(19) United States
(12) Patent Application Publication
(10) Pub. No.: US 2018/0297253 A1
(43) Pub. Date: Oct. 18, 2018

(54) METHOD FOR JOINING TWO COMPONENTS OF DIFFERENT MATERIALS

(71) Applicant: TESA SE, Norderstedt (DE)

(72) Inventors: Arnaud FUSSELIER, Cesson (FR); Marco BALBO-BLOCK, Hamburg (DE)

(73) Assignee: TESA SE, Norderstedt, OT (DE)

(21) Appl. No.: 15/767,411

(22) PCT Filed: Oct. 12, 2016
(86) PCT No.: PCT/EP2016/074490

§ 371 Date: Apr. 11, 2018

(30) Foreign Application Priority Data
Oct. 13, 2015 (DE) 10 2015 219 798.0

(51) Int. Cl. B29C 45/14; B29C 45/26; B29C 45/40

(52) U.S. Cl. CPC B29C 45/14311; B29C 45/26; B29K 2705/12; B29C 2045/14868; B29C 45/40

(57) ABSTRACT

One or more processes produce a metal-plastic composite, wherein the one or more processes: apply an adhesive tape to a surface of a metal part that requires adhesive bonding; place the metal part into a closed hollow mold; inject thermoplastic material into the hollow mold so that the plastic encloses the adhesive tape; and remove the resulting metal-plastic composite from the hollow mold.

The present invention relates to a process for the bonding of two components of different materials, for example metal-plastic or plastic-plastic.

Use of metal-plastic composite materials and plastic-plastic composite materials in lightweight (automobile) construction is constantly increasing. Another possibility is use of metal decorative elements in the finishing of plastics surfaces.

Metal elements, for example metal sheets, can be joined to the finished plastics subcomponent by adhesive bonding or off-line (additional operation). Alternatively, in an injection-molding process, the metal element can be placed in a mold and a liquid plastics composition can be used for overmolding or in-mold coating of same.

Details relating to injection molding can be found in Chemielexikon Rompp [Rompp's Chemical Encyclopedia], and specifically under the heading “Injection molding” (2013 Georg Thieme Verlag, document identifier RD-19-03499, latest update: July 2011).

Adhesion between plastics and metal in the injection-molding process is generally poor to very poor, in particular in the case of nonpolar plastics. An interlock connection (overmolding) or a frictional connection (force-fit) is used as mechanical means of holding the two materials together; this is particularly problematic with metal elements in external contact, for example in the in-mold-coating process. Shrinkage and distortion during the cooling step of the injection-molding process can lead to stresses between metal and plastic and finally to cracking or splitting. There are generally only limited possibilities for transfer of forces between the two materials, and also for impermeability to liquids. Mechanical and thermal stress can also weaken the bond and can lead to various types of fatigue in the materials. A coherent (adhesive) bond between metal and plastic is therefore always preferable.

An adhesive bond increases the overall strength of the composite, and its durability and integrity, by dissipating stress peaks and compensating mechanically/thermally induced deformation differences. There are various approaches to achievement of an adhesive bond. A traditional method uses a physical or chemical method to pretreat the metal surface (preferably shortly prior to composite production or directly in the injection mold). This can firstly be a plasma treatment or the like, or secondly the metal surface can be treated with a chemical primer or with a liquid adhesive, or equipped with a lacquer coating or other (plastics) coating. All of the variants involve complicated handling or large capital expenditure, and/or may be hazardous to health. Plasma does not produce any resilient/compensating intermediate layer, and moreover a suction system is required for the removal of ozone and other gases. A primer has the disadvantage that it requires drying (flash-off time) after application, and can be hazardous to health by virtue of the solvents that evaporate. Liquid adhesives also require a certain time for hardening, are potentially hazardous to health and, as a consequence of excessive pressure in the mold, can “exude” and spread beyond the area intended for adhesive bonding.

It is an object of the present invention to provide an optimized process for the production of a metal-plastic composite or of a plastic-plastic composite.

This object is achieved via a process as set out in the main claim. The dependent claims provide advantageous embodiments of the subject matter of the invention.

Accordingly, the invention describes a process for the production of a metal-plastic composite, comprising the following steps:
application of an adhesive tape to that surface of a metal part that requires adhesive bonding
placing of the metal part into a closed, preferably two-part hollow mold
injection of the thermoplastic into the hollow mold so that the plastic encloses the adhesive tape
removal of the metal-plastic composite from the hollow mold.

Alternatively, it is also possible in the invention to use the same steps to produce a plastic-plastic bond:
application of an adhesive tape to that surface of a plastics part that requires adhesive bonding
placing of the plastics part into a closed, preferably two-part hollow mold
injection of the second thermoplastic into the hollow mold so that the second plastic encloses the adhesive tape
removal of the plastic-plastic composite from the hollow mold.

When the expression metal-plastic composite is used hereinafter, its meaning also includes a plastic-plastic composite.

The adhesive tape acts in the invention as adhesion promoter in the metal-plastic-injection-molding process. It permits production of composite materials combining highest product performance, highest product quality, highest product safety and highest product cost-effectiveness. It can also provide new types of composite components and new types of composite geometries. The process is reliable and clean, and requires no exhaust-air equipment and no additional downstream work. Application of the adhesive tape can be decoupled chronologically and spatially from the injection-molding process, and indeed can be outsourced.

The adhesive tape is applied in the invention to the metal surface that is to be adhesive-bonded. The metal element is then placed into the injection mold (with the adhesive tape side facing inward into the mold in the case of in-mold coating), and the injection-molding step is carried out. The required minimum of adhesion between metal and plastic is present as soon as the composite component is removed from the mold. The adhesion and/or cohesion of the adhesive bond preferably then increases after a certain post-curing time and/or in a post treatment step.

The expression adhesive tapes is intended here, for the purposes of the invention, to mean any carrier structure which takes the form of a sheet or strip and has a coating of adhesive on one or both sides, i.e. not only traditional tapes but also labels, sections, punched products (punched carrier sheets coated with adhesive), structures extended in two dimensions (for example films) and the like, and also multilayer arrangements.

The expression “adhesive tape” also comprises what are known as “transfer adhesive tapes”, i.e. a carrierless adhesive tape. In the case of a transfer adhesive tape, prior to application the adhesive is applied between flexible liners to which a release layer has been provided and/or which have antiadhesive properties. For application, one liner is generally first removed, the adhesive is applied, and then the second liner is removed.

The adhesive tape can be provided in fixed lengths, for example by the yard, or else as continuous product on rolls (Archimedean spirals).

The adhesive tape must have the desired adhesion to the metal surface, and must withstand the injection-molding process without undergoing any disproportionate undesirable changes. It is possible in principle to use either single-sided or double-sided adhesive tapes. Single-sided adhesive tapes then preferably have a rough and/or open-pore surface (for mechanical adhesion) or have a carrier that exhibits the required minimum of compatibility with the injection plastic. However, preference is given to double-sided or carrierless adhesive tapes. Particular preference is given to what are known as reactive adhesive tapes, but it is also possible to use thermoplastic adhesive tapes, with or without carrier. Reactive adhesive tapes comprise latent chemically reactive molecular groups which, under the injection-molding conditions in the mold (pressure, temperature, time), react with one another and/or with the plastic/metal and thus, among one another and/or with the substrate, construct a molecular network. Alternatively, the reaction of the adhesive tape can also be initiated by an exterior stimulus (light, UV radiation, plasma, or introduction of an initiator in the form of a solution or of a second, complementary adhesive tape, etc.) before the injection-molding step.

The formulation and structure of the adhesive tape, and therefore its polarity (plastic/metal affinity), reaction conditions and reaction chemistry can be adjusted as required for the desired injection-molding conditions and selected plastic and selected metal. The polarity/chemistry of the adhesive tape is ideally compatible with both of the substrates to be adhesive-bonded, thus acting to reduce the effect of large differences between metal and plastic.

Examples of classes of reactive adhesive tape are epoxy-, acrylate-, phenol-formaldehyde-resin- and isocyanate-containing adhesive tapes. The adhesive tape can also involve a mixture of two chemical classes, each of which per se permits ideal adhesion to one of the substrates.

Possible metal elements can be made of steel or aluminum.

Possible injection-molding plastics can be any desired thermoplastics or thermosets, inter alia ABS, PP, PA, PUR.

The adhesive tape can optionally:
be rendered foamable.
exhibit resilient and/or viscoelastic properties, in order additionally to compensate stresses.
comprise a carrier or laid-fiber material by way of example to prevent flow phenomena.
be composed of a plurality of layers, for example functional layers, and also be of symmetrical or asymmetrical structure (in each dimensional direction).
have different thicknesses within the adhesive-bonding area and planar or nonplanar, structured or non-structured (surface) topographies.
be applied over an entire surface or part of a surface, and also at any desired time before or during the process.

The described use of adhesive tapes can be combined with known surface pretreatments, for example plasma pretreatments or primer pretreatments.

The principle can not only be used for metal-plastic composite materials, but as has been stated in the invention is also suitable when the intention is to bond two very different plastics in an injection-molding process, for example

The invention will be explained in more detail below with reference to a number of examples, without any intention that these in any way restrict the invention.

### Metal-Plastic Composite

A steel frame is to be provided to an injection-molded plastics sheet (4) made of polyamide in a manner that permits screwing and welding of the entire component. An example of said component is the spare tire holder, which is made of plastic, under the trunk, and which is to be welded to the bodywork by mechanical means.

A reactive adhesion-promoting adhesive tape (3), Tesa® HAF 8400, is applied in advance on one side of the steel frame, and the steel frame with adhesive tape is placed into a suitable injection mold (with the adhesive tape side directed inward).

Tesa® HAF 8400 is a heat-activatable carrierless film based on nitrile rubber and phenolic resin. It has a strong paper liner. At room temperature the material is not tacky. The activation temperature for prefixing is about 90° C. In a second processing step, the product is applied with introduction of pressure and heat.

The hot liquid polyamide is injected (2) into the closed mold (1). By virtue of the high temperature and high pressure in the, now filled, mold, the Tesa® HAF 8400 crosslinks and forms bonds both at the interface with the metal and at the interface with the polyamide. Once the polyamide has hardened, the component can be removed from the mold. When comparison is made with the situation without HAF adhesion promoter, the steel frame and the solidified polyamide have now been bonded by the Tesa® HAF 8400 in a manner that can withstand greater forces.

In an alternative embodiment, a tubular metal element (5) with adhesive-tape adhesion promoter (3) is subjected to overmolding in a mold.

Particularly advantageous embodiments of the invention are explained in more detail with reference to the figures described below, in which

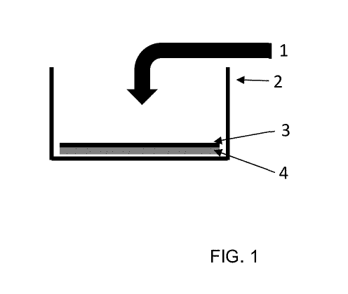

FIG. 1 shows a plastics sheet equipped with adhesive-tape adhesion promoter and subjected to in-mold coating in a mold, and

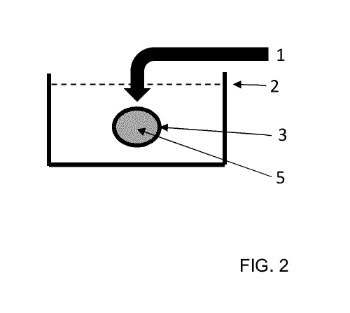

FIG. 2 shows a tubular metal element equipped with adhesive-tape adhesion promoter and subjected to overmolding in a mold.

1. A process for producing a metal-plastic composite, the process comprising:
applying an adhesive tape to a surface of a metal part that requires adhesive bonding;
placing the metal part into a closed hollow mold;
injecting thermoplastic material into the hollow mold such that the thermoplastic material encloses the adhesive tape to produce a metal-plastic composite; and
removing the metal-plastic composite from the hollow mold.

2. A process for producing a plastic-plastic composite, the process comprising
applying an adhesive tape to a surface of a plastics part that requires adhesive bonding;
placing the plastics part into a close hollow mold;
injecting a thermoplastic material into the hollow mold such that the thermoplastic material encloses the adhesive tape to produce a plastic-plastic composite; and
removing of the plastic-plastic composite from the hollow mold.

3. The process according to claim 1, wherein the adhesive tape is double-sided or carrierless.

4. The process according to claim 1, wherein the adhesive tape is a reactive adhesive tape.

5. The process according to claim 1, wherein, by virtue of a foaming procedure, the adhesive tape is configured to reduce possible stresses or to reduce formation of cavities due to shrinkage.

6. The process according to claim 1, wherein the closed hollow mold is a two-part hollow mold.

7. The process according to claim 2, wherein the closed hollow mold is a two-part hollow mold.

8. The process according claim 2, wherein the adhesive tape is double-sided or carrierless.

9. The process according to claim 2, wherein the adhesive tape is a reactive adhesive tape.

10. The process according to claim 2, wherein, by virtue of a foaming procedure, the adhesive tape is configured to reduce possible stresses or to reduce formation of cavities due to shrinkage.
